(19) United States
(12) Patent Application Publication
(10) Pub. No.: US 2011/0149074 A1
(43) Pub. Date: Jun. 23, 2011

(54) PORTABLE MULTI-VIEW IMAGE ACQUISITION SYSTEM AND MULTI-VIEW IMAGE PREPROCESSING METHOD

(75) Inventors: Seung Wook LEE, Daejeon (KR); Ho Won KIM, Daejeon (KR); Chang Woo CHU, Daejeon (KR); Bon Ki KOO, Daejeon (KR)

(73) Assignee: Electronics and Telecommunications Research Institute, Daejeon (KR)

(21) Appl. No.: 12/971,727

(22) Filed: Dec. 17, 2010

(30) Foreign Application Priority Data
Dec. 18, 2009 (KR) 10-2009-0127368
Jun. 11, 2010 (KR) 10-2010-0055675

(51) Int. Cl. H04N 7/18

(52) U.S. Cl. 348/143; 348/E07.085

(57) ABSTRACT

Provided are a portable multi-view image acquisition system and a multi-view image preprocessing method. The portable multi-view image acquisition system may include: a portable studio including a plurality of cameras movable up, down, left and right; and a preprocessor performing a preprocessing including a subject separation from a multi-view image that is photographed by the plurality of cameras.

### CROSS-REFERENCE TO RELATED APPLICATIONS

This application claims priority under 35 U.S.C. §119 to Korean Patent Application No. 10-2009-0127368, filed on Dec. 18, 2009, and Korean Patent Application No. 10-2010-0055675, filed on Jun. 11, 2010, in the Korean Intellectual Property Office, the disclosures of which are incorporated herein by reference in its entirety.

### TECHNICAL FIELD

The present invention relates to a portable multi-view image acquisition system and a multi-view image preprocessing method that may acquire a multi-view image in an inexpensive portable system and preprocess the acquired multi-view image and then use the preprocessed multi-view image for an application program.

### BACKGROUND

With developments in an image technology, a computer vision, and a computer graphics technology, an existing two-dimensional (2D) multimedia technology is evolving into a three-dimensional (3D) multimedia technology. A user desires to view a more vivid and realistic image and thus various 3D technologies are combined with each other.

For example, in the field of sports broadcasting, when synchronized multiple images are acquired by installing a plurality of cameras at various angles and taking pictures to vividly transfer motions of players running in a stadium, and are selectively combined, it is possible to provide, to viewers, an image giving a feeling as though they are viewing an instantaneous highlight scene from the best seat with various perspectives from a stand in the stadium. A technology to provide the image in the above manner is referred to as a flow motion technology, which was used in the movie “Matrix”, and thereby has become famous. In addition, when using the plurality of cameras, a 3D model may be configured with respect to a front view and thus it is possible to perform various types of application programs using the 3D model.

A basic goal of the above service is to initially acquire a multi-view image. However, to acquire the multi-view image, a configuration of expensive equipment and studio may be required. For example, to acquire the multi-view image, a studio equipped with a blue screen and a lighting may be required. To configure such a studio, expensive equipment and a physically large studio space may be required. Due to the above reasons, it may be difficult to acquire the multi-view image, which may hinder the development of a 3D-based image service industry. In addition, the common preprocessing process for the acquired multi-view image, for example, a subject separation, a camera calibration, and the like may be required.

### SUMMARY

An exemplary embodiment of the present invention provides a portable multi-view image acquisition system, including: a portable studio including a plurality of cameras movable up, down, left and right; and a preprocessor performing a preprocessing including a subject separation from a multi-view image that is photographed by the plurality of cameras.

Another exemplary embodiment of the present invention provides a preprocessing method of a multi-view image photographed in a portable studio including a photographing space and a plurality of cameras photographing the photographing space, the method including: generating a first subject separation reference image acquired by photographing, using a basic lighting, the photographing space where a subject does not exist, and a second subject separation reference image acquired by photographing, using a color lighting, the photographing space where the subject does not exist; determining whether the subject has the same color as a background within the photographing space; and separating the subject from an image acquired by photographing the subject, using the first subject separation reference image or the second subject separation reference image depending on the decision result.

Still another exemplary embodiment of the present invention provides a preprocessing method of a multi-view image photographed in a portable studio including a photographing space and a plurality of cameras photographing the photographing space, the method including: photographing each of a case where a subject exists within the photographing space marked by a marker and a case where the subject does not exist within the photographing space marked by the marker, using the plurality of cameras; extracting coordinates of the marker from an image corresponding to each of the cases, and determining whether a difference of coordinates of the marker between the two images is greater than a threshold; and calibrating the plurality of cameras depending on the decision result.

Other features and aspects will be apparent from the following detailed description, the drawings, and the claims.

### BRIEF DESCRIPTION OF THE DRAWINGS

FIG. 1 is a block diagram illustrating a portable multi-view image acquisition system according to an exemplary embodiment of the present invention;

FIG. 2 through FIG. 4 are exemplary diagrams to describe a structure of a portable studio of FIG. 1;

FIG. 5 and FIG. 6 are diagrams to describe a lighting used in the portable studio of FIG. 1;

FIG. 7 is a flowchart illustrating a multi-view image preprocessing method according to another exemplary embodiment of the present invention;

FIG. 8 is a perspective view illustrating a calibration pattern apparatus for a calibration; and

FIG. 9 is a conceptual diagram to describe a multi-view image preprocessing method according to still another exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

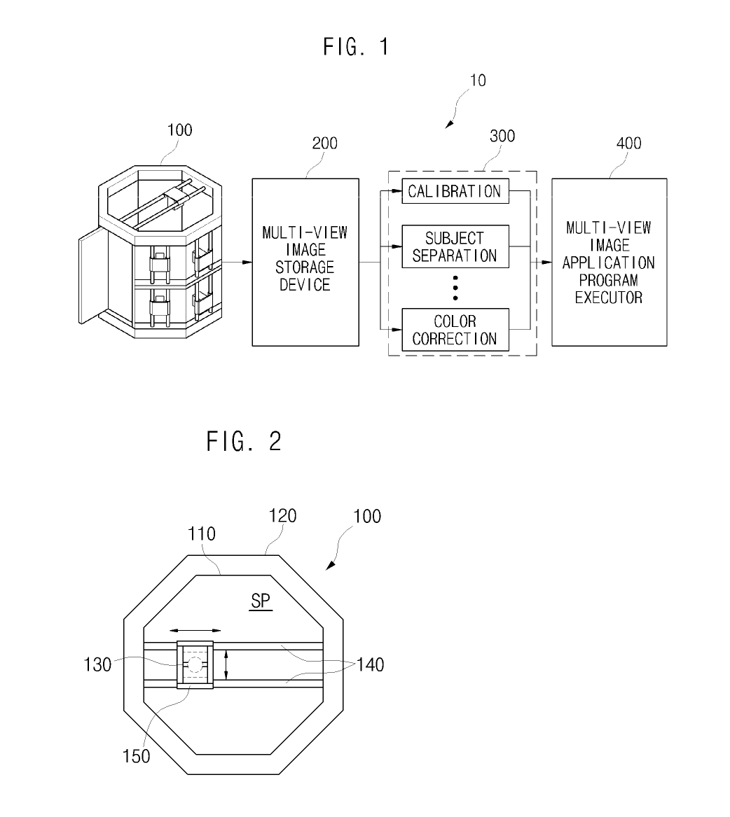

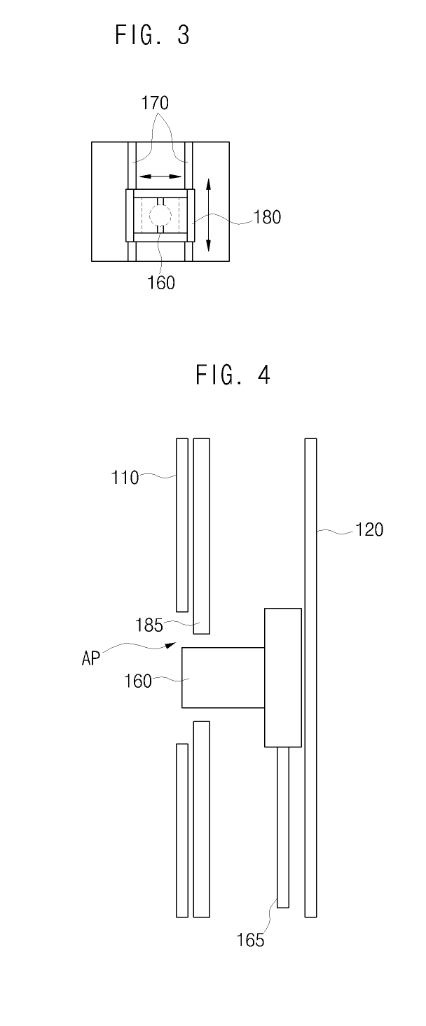

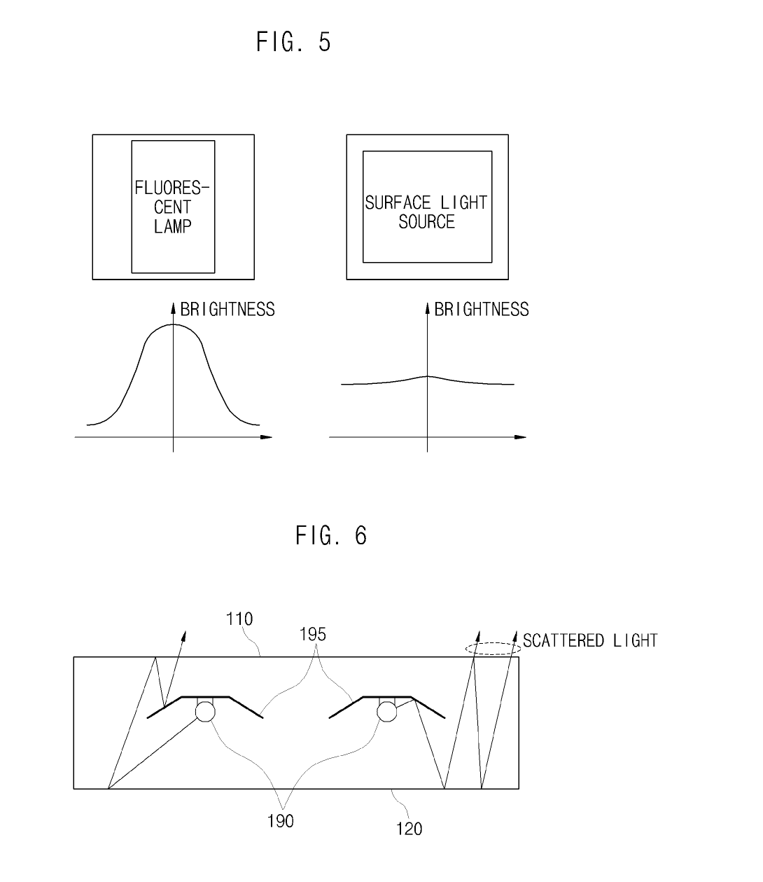

Hereinafter, a portable multi-view image acquisition system according to the exemplary embodiments of the present invention will be described to FIG. 1 through FIG. 9. FIG. 1 is a block diagram illustrating a portable multi-view image acquisition system according to an exemplary embodiment of the present invention, FIG. 2 through FIG. 4 are exemplary diagrams to describe a structure of a portable studio of FIG. 1, and FIG. 5 and FIG. 6 are diagrams to describe a light used in the portable studio.

As shown in FIG. 1, the portable multi-view image acquisition system 10 according to an exemplary embodiment of the present invention may include the portable studio 100, a multi-view image storage device 200, a preprocessor 300, and an application program executor 400.

In the portable multi-view image acquisition system 10, a multi-view image may be acquired through photographing in the portable studio 100, and the acquired multi-view image may be transmitted to the multi-view image storage device 200 and be stored therein. The multi-view image may be processed by the preprocessor 300 and be used for various application programs by the application program executor 400. For example, the various application programs may include a three-dimensional (3D) model reconstruction, a 3D video of motion picture experts group (MPEG), a flow motion, and the like. Hereinafter, descriptions will be made based on a structure of the portable studio 100 and an operation of the preprocessor 300.

Initially, the portable studio 100 will be described in detail with reference to FIG. 1 through FIG. 6.

The portable studio 100 may be provided in a 3D form in order to configure, within an inside of the portable studio 100, a photographing space SP for photographing. For example, the portable studio 100 may be provided in a form of a polyprism (an octagonal pillar in the present exemplary embodiment). Cylindrical surfaces of the portable studio 100 of the polyprism may be separable and combinable with each other in order to be suitable for a disassembly, a relocation, and a reassembly. The portable studio 100 may be provided in a form of a circular cylinder, or may be provided in another arbitrary form. Hereinafter, a case where the portable studio 100 is provided in the form of an octagonal pillar will be described as an example.

As shown in FIG. 1 and FIG. 2, in the portable studio 100 in the form of the octagonal pillar, each surface of eight surfaces may include two cells, that is, an upper cell and a lower cell, and thus the eight surfaces may include 16 (2×8) cells in a shape of a square. Each of a top surface and a bottom surface of the octagonal pillar may include four (2×2) cells by dividing an octagon into two pieces. Accordingly, the portable studio 100 in the form of the octagonal pillar may be manufactured by assembling a total of 20 unit cells. However, it is only an example and thus the shape and the structure of the portable studio 100, and a number of cells and shapes constituting the portable studio 100 may be diversified.

Referring to a top view of the portable studio 100 shown in FIG. 2, the portable studio 100 may include an entrance door, an inner wall 110, an outer wall 120, upper camera rails 140 and 150, an upper camera 130, and the like.

As shown in FIG. 3 through FIG. 6, a lighting, side cameras 160, side camera rails 170 and 180, and the like may be disposed between the inner wall 110 and the outer wall 120 of the portable studio 100.

A lighting, for example, a surface light source may be emitted towards the photographing space SP, and a subject (generally, a human being) may stand with his/her back against the entrance door. The upper camera 130 may acquire an upper texture (for example, a shoulder portion, an upper portion of a head) that may not be acquired using the plurality of side cameras 160. To acquire all the textures of the subject, the side cameras 160 may be freely disposed. For example, each of the side cameras 160 may be disposed in each of the cells constituting the octagon. As shown in FIG. 2 and FIG. 3, the upper camera 130 and the side cameras 160 may move up and down, or left and right along the respective corresponding camera rails 140, 150, 170, and 180. In addition, a manipulation of a pan and a tilt may become possible.

An important issue in the subject separation is how to unify a background image. According to an exemplary embodiment of the present invention, for photographing, as shown in FIG. 4, an opening area AP may exist in one portion of the inner wall 110. The side camera 160 may be positioned to take a picture via the opening area AP. In this case, the side camera 160 positioned on one surface of the octagonal pillar may be photographed by another side camera 160 positioned on the facing surface, and thus it is difficult to maintain a static status. For this, according to an exemplary embodiment of the present invention, a double frame structure may be used as shown in FIG. 4.

Specifically, a moving frame 185 of the same material as the inner wall 110 may be disposed right behind the inner wall 110 where the opening area AP is formed. Every time the side camera 160 moves up, down, left, and right, the moving frame 180 may move together with a lens of the side camera 160. In this case, even though the side camera 160 moves, an area excluding the lens of the side camera 160 in the opening area AP may be blocked by the moving frame 185. In the above manner, a static background where the side camera 160 of the opposite side faces only the lens of the facing side camera 160 may be completed. Here, the term “static” indicates a status where only a background and a lens portion of a camera appear and thus a front background separation is very easy. A camera stand 165 corresponds to an instrument connecting the side camera 160 and the side camera rail 180.

The lighting supplying a light to the photographing space SP within the portable studio 100 may be a surface light source. As shown in FIG. 5, in the case of a general fluorescent lamp, a brightness may significantly increase right around the fluorescent lamp, whereas the brightness may significantly decrease in a neighboring portion. When the fluorescent lamp is used as the lighting, a color of the acquired multi-view image may not be matched to a color of an image of a viewpoint photographing a portion where a relatively large amount of lighting is provided, and an image of another viewpoint photographing a portion where a relatively small amount of lighting is provided. Accordingly, it may become an issue. On the other hand, in the case of the surface light source, the brightness may be uniformly distributed and thus it is possible to resolve a color matching problem of the multi-view image occurring due to the lighting.

To solve the above problem, it is possible to exhibit the same function as the surface light source by employing a lighting device structure as shown in FIG. 6. That is, a light source 190 may be provided between the inner wall 110 and the outer wall 120 and the inner wall 110 may spread the light source 190 and thereby is enabled to perform a defuser function. For example, the inner wall 110 may be enabled to perform the defuser function by roughly forming the inner wall 110 through sanding with respect to an acrylic panel. In addition, by reflecting a light emitted from the light source 190 towards the outer wall 120 using a reflecting member 195, and by reflecting again the light, emitted towards the outer wall 120 by means of the reflecting member 195, towards the inner wall 110 by means of the outer wall 120, the lighting device is enabled to exhibit the same effect as the surface light source. Here, an inner surface of the outer wall 120 may be coated with a material that enables a total reflection and a scattering reflection. Through this, the light may be uniformly distributed between the inner wall 110 and the outer wall 120. The reflecting member 195 used here may use a material of which both sides may be reflected. Thus, a scattered light may also exist as shown in FIG. 6. Here, a light source may be a multi-light source. The multi-light source may include various colors of color light in addition to a white light.

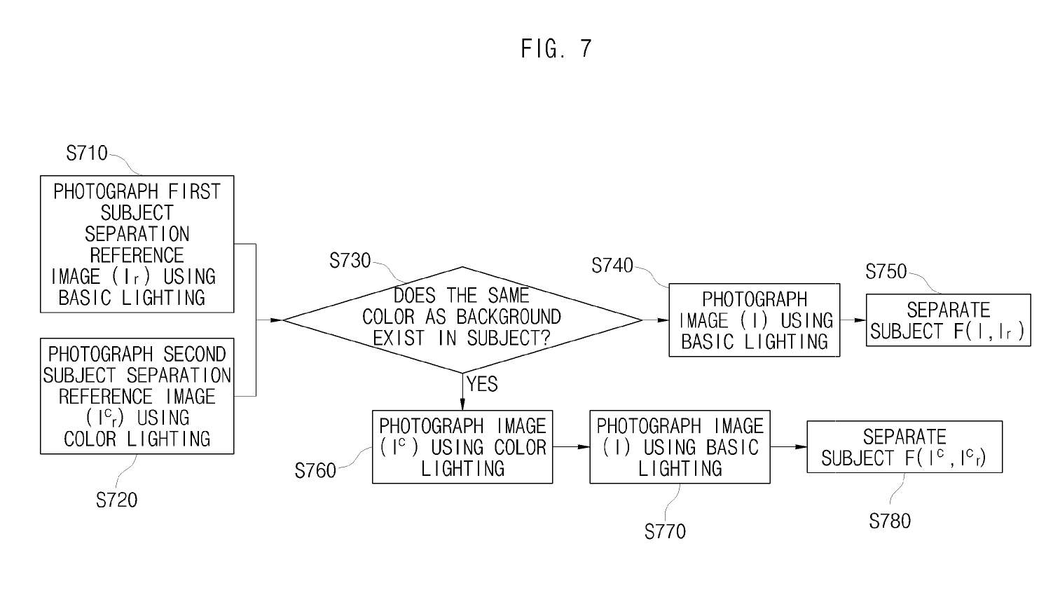

The preprocessor 300 of FIG. 1 may perform various processes according to an application program executed by the application program executor 400. For example, the preprocessor 300 may perform a subject separation from the multi-view image acquired through photographing in the portable studio 100. Hereinafter, a process of separating, by a portable multi-view image acquisition system, a subject from a multi-view image according to an exemplary embodiment of the present invention will be described with reference to FIG. 7.

FIG. 7 is a flowchart illustrating a multi-view image preprocessing method according to another exemplary embodiment of the present invention.

Referring to FIG. 1 and FIG. 7, the preprocessor 300 may emit a basic lighting (190 of FIG. 6), for example, a white light and photograph a background image (hereinafter, a first subject separation reference image, Iᵣ) (S710), and may photograph a background image (hereinafter, a second subject separation reference image, I^{c}ᵣ) using a color lighting (S720). In this instance, a subject may not move. The preprocessor 300 may determine whether the same color as the basic lighting exits in the subject (S730), and may photograph an image I using the basic lighting when the same color does not exist (S740). The preprocessor 300 may separate the subject from the image photographed in operation S740 using the first subject separation reference image (S750). For example, the preprocessor 300 may separate the subject by using a subject separation function F( ) for example, by performing F(I, Iᵣ), and performing a differentiation of two images. Also, the preprocessor 300 may use another algorithm. Conversely, when the same color as the basic lighting exists in the subject, the preprocessor 300 may photograph an image I^{c} using the color lighting (S760). The preprocessor 300 may separate the subject from the image photographed in operation S760 using the second subject separation reference image (S780). For example, the preprocessor 300 may separate a subject image by performing a subject separation function F(I^{C}, I^{c}ᵣ). Here, even though the same color as the basic lighting exists in the subject, the application program may use the image photographed using the basic lighting. Therefore, the preprocessor 300 may photograph the image using the basic lighting (S770). Specifically, when the same color as the basic lighting exists in the subject, operations S760 and S780 may be performed for the subject separation. When the application program uses the multi-view image, the image photographed using the basic lighting in operation S770 may be used.

In the meantime, two cases may be considered in association with a calibration of cameras 130 and 160. First, the cameras 130 and 160 to be fixed at an arbitrary position may be adjusted to have the same coordinates system. Second, the portable multi-view image acquisition system 10 may be manufactured so that the cameras 130 and 160 may not mechanically move. Since the cameras 130 and 160 may shake over a long period of use, the portable multi-view image acquisition system 10 may inform a user about whether the cameras 130 and 160 shake. When the cameras 130 and 160 shake, there is a need to update a camera parameter to a camera parameter corresponding to a status where the cameras 130 and 160 shake.

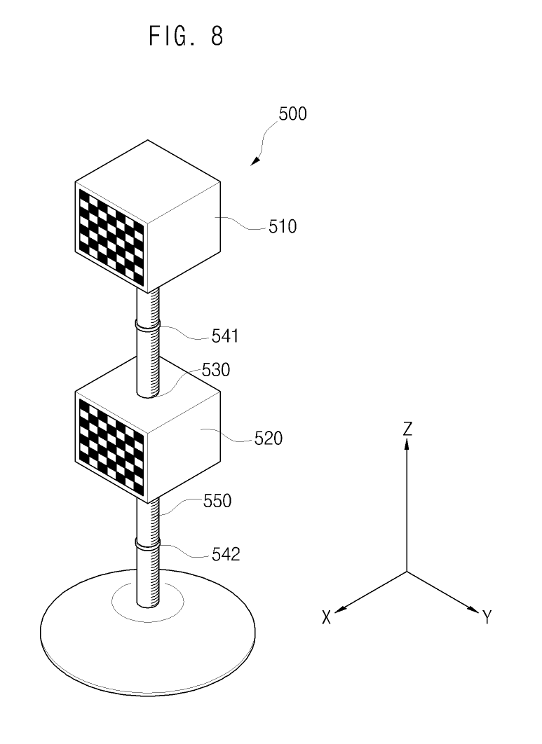

Initially, a process of performing, by the preprocessor 300, a calibration of the cameras 130 and 160 so that the cameras 130 and 160 may have the same coordinates system will be described with reference to FIG. 8. FIG. 8 is a perspective view illustrating a calibration pattern apparatus 500 for a calibration.

As shown in FIG. 8, the calibration pattern apparatus 500 may include two pattern display units 510 and 520, and height adjustment units 541 and 542.

A calibration pattern may be photographed by all the cameras 130 and 160 so that all the cameras 130 and 160 may have the same coordinates system. As shown in FIG. 1, two side cameras are disposed in an upper portion and a lower portion on each surface of the octagonal pillar. Thus, the calibration pattern apparatus 500 may be disposed so that the calibration pattern may be photographed by two cameras disposed on each surface. For example, the two pattern display units 510 and 520 may be connected to each other in a vertical direction (Z direction) via a combining unit 530 and thereby be disposed. A distance between the two cameras 130 and 160 disposed on each surface may be variable. Accordingly, the height adjusting units 541 and 542 may be disposed so that a distance between the pattern display units 510 and 520 may be appropriately adjusted, whereby the distance and height between the pattern display units 510 and 520 may be adjustable.

When each of the cameras 130 and 160 disposed on each one surface of the octagonal pillar photographs the calibration pattern of the display patterns 510 and 520, the preprocessor 300 may perform the calibration so that the cameras 130 and 160 may have the same coordinates system, using feature point coordinates of each photographed calibration pattern, a numerical value of a graduated ruler 550 marked on the height adjustment units 541 and 542 at a photographed viewpoint, and the like.

In this instance, the height of the pattern display units 510 and 520 may be adjusted by means of the height adjustment units 541 and 542, and the pattern display units 510 and 520 may be combinable with each other or be separable from each other by means of the combining unit 530. Accordingly, the calibration may be performed regardless of an arraignment structure and position between the cameras 130 and 160.

An internal factor such as a focal distance, principal coordinates, a distortion coefficient, and the like may be pre-calculated for each zoom level of a lens of each of the cameras 130 and 160. When the cameras 130 and 160 correspond to digital cameras, a lookup table may be generated by pre-calculating an internal factor with respect to a focal distance value of an exchangeable image file format (EXIF). According to an actual zoom value, an internal factor may be taken from the lookup table. Or, a value may be acquired through interpolation and thereby be used for calculating an external factor.

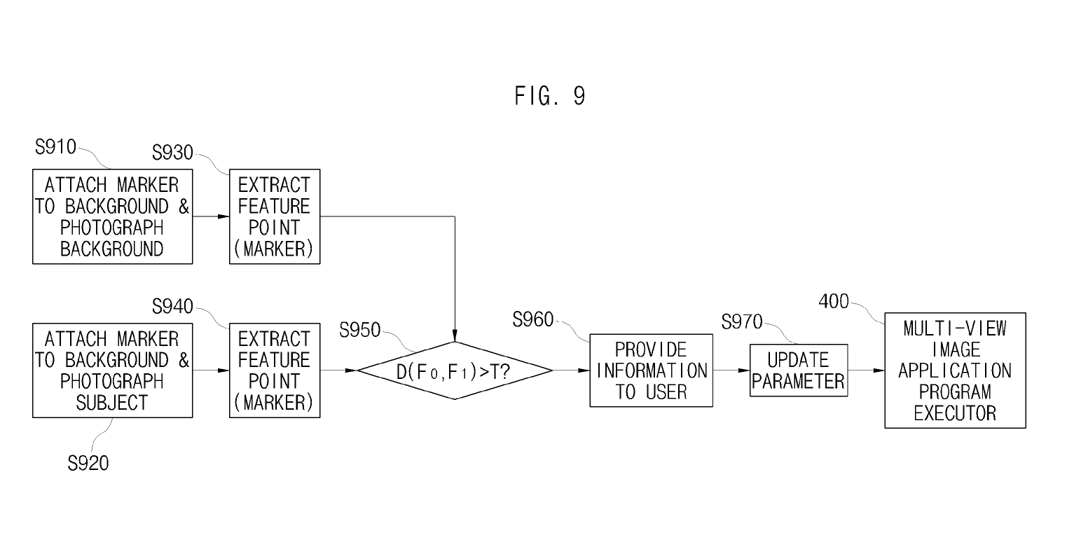

Next, a process of verifying, by the preprocessor 300, shaking of the cameras 130 and 160 and thereby updating parameters of the cameras 130 and 160 will be described with reference to FIG. 9. FIG. 9 is a conceptual diagram to describe a multi-view image preprocessing method according to still another exemplary embodiment of the present invention

Initially, each of the cameras 130 and 160 may attach an indicator (marker) to the inner wall 110 of the portable studio 100 and photograph a background (S910). The preprocessor 300 may extract two-dimensional (2D) coordinates of the indicator and a feature point F₀ from an image of a background photographed by the cameras 130 and 160 after calibration (S930). Also, in a status where the indicator (marker) is attached to the inner wall 110 of the portable studio 100, each of the cameras 130 and 160 may photograph a subject (S920). The preprocessor 300 may extract 2D coordinates of the indicator and a feature point F₁ from an image of the subject photographed by the cameras 130 and 160 after calibration (S940).

The preprocessor 300 may calculate a position difference between the feature points F₁ and F₂ extracted from two images, and compare the position difference and a predetermined threshold T (S950). When the position difference is greater than the predetermined threshold T, the preprocessor 300 may inform a user about that the cameras 130 and 160 currently shake (S960). In this case, the preprocessor 300 (or the user) may compare information associated with the feature point F₀ extracted from the background image with information associated with the feature point F₁ extracted from the image including the subject, and calculate how much the cameras 130 and 160 have moved, and thereby update parameters of the cameras 130 and 160 (S970). Conversely, when the position difference is less than or equal to the threshold T, the preprocessor 300 may determine that the cameras 130 and 160 do not shake. The updated parameters of the cameras 130 and 160 and may be transferred to the application program and be used for image processing.

The indicator to determine a validity of cameras 130 and 160 calibration value as described above may be attached at an arbitrary position within the inner wall 110 of the portable studio 100. In this instance, a predetermined number of indicators may be uniformly distributed so that a similar number of indicators may be photographed by means of all the cameras 130 and 160. In addition, the indicator may be attached to have a size visually identifiable in a corresponding image.

According to the exemplary embodiments of the present invention, it is possible to configure a portable multi-view image acquisition system. Since all the textures of a subject may be acquired by adjusting a position and a direction of a camera and a multi-view image may be acquired using a lighting closer to a surface light source, a relatively good result may be acquired by driving an application program using the acquired multi-view image. In addition, since a subject separation may be easily performed using a color lighting, shaking of a camera may be automatically identified and be corrected. Accordingly, a calibration for the camera may be efficiently performed.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A portable multi-view image acquisition system, comprising:
a portable studio including a plurality of cameras movable up, down, left and right; and
a preprocessor performing a preprocessing including a subject separation from a multi-view image that is photographed by the plurality of cameras.

2. The system of claim 1, wherein the portable studio includes:
a photographing space;
a plurality of side cameras photographing a side surface of a subject within the photographing space;
at least one upper camera photographing an upper surface of the subject; and
a side camera rail and an upper camera rail for up, down, left, and right movements of each of the side cameras and the at least one upper camera.

3. The system of claim 2, wherein the portable studio includes:
an inner wall frame constituting the photographing space;
an outer wall frame surrounding the inner wall frame; and
a lighting being disposed between the inner wall frame and the outer wall frame, and
the side camera rail and the side camera are disposed between the inner wall frame and the outer wall frame.

4. The system of claim 3, wherein the inner wall frame includes an opening area enabling the side camera to photograph the photographing space while moving up and down, and
the portable studio further includes:
a moving frame moving up and down along the side camera when the side camera moves up and down, and blocking an area excluding a lens of the side camera in the opening area.

5. The system of claim 3, wherein the portable studio further includes:
a reflecting member being disposed between the lighting and an inner wall to reflect a light emitted from the lighting towards an outer wall,
a material totally reflecting or scattering the light is applied on one surface of the outer wall facing the lighting, and
the inner wall spreads the light towards the photographing space.

6. The system of claim 2, wherein when the subject has the same color as a background within the photographing space, the preprocessor performs the subject separation using an image acquired by photographing the photographing space where the subject exists using a color lighting, and an image acquired by photographing the photographing space where the subject does not exist using the color lighting.

7. The system of claim 6, wherein when the subject does not have the same color as the background, the preprocessor performs the subject separation using an image acquired by photographing the photographing space where the subject exists using a white lighting, and an image acquired by photographing the photographing space where the subject does not exist using the white lighting.

8. The system of claim 7, wherein the preprocessor photographs the photographing space where the subject does not exist using each of the white lighting and the color lighting,
the preprocessor photographs the subject to thereby determine whether the subject has the same color as the background, and performs the subject separation depending on the decision result.

9. The system of claim 2, wherein the preprocessor performs a calibration so that the plurality of side cameras have the same coordinates system using a result that is obtained by photographing a calibration pattern.

10. The system of claim 2, wherein the preprocessor extracts coordinates of a marker from each of an image acquired by photographing a case where the subject exists in the photographing space marked by the marker, and an image acquired by photographing a case where the subject does not exist in the photographing space marked by the marker, determines whether a difference of coordinates of the marker between the two images is greater than a threshold, and performs a calibration with respect to at least one of a position of a camera, a tilt thereof, a pan thereof, and a parameter thereof depending on the decision result.

11. The system of claim 1, wherein the portable studio is provided in a form of a polyprism, and cylindrical surfaces of the polyprism are separable from each other and are combinable with each other,
each of the cylindrical surfaces are configured by combining at least two separable cells,
a side camera among the plurality of cameras is disposed for each of the at least two cells and an upper camera among the plurality of cameras is disposed on an upper surface of the polyprism to thereby move up, down, left, and right in order to generate a multi-view image, and to photograph the photographing space that is an inside of the polyprism.

12. A preprocessing method of a multi-view image photographed in a portable studio including a photographing space and a plurality of cameras photographing the photographing space, the method comprising:
generating a first subject separation reference image acquired by photographing, using a basic lighting, the photographing space where a subject does not exist, and a second subject separation reference image acquired by photographing, using a color lighting, the photographing space where the subject does not exist;
determining whether the subject has the same color as a background within the photographing space; and
separating the subject from an image acquired by photographing the subject, using the first subject separation reference image or the second subject separation reference image depending on the decision result.

13. The method of claim 12, wherein the determining includes:
photographing the subject existing within the photographing space using the plurality of cameras; and
determining whether the subject has the same color as the background within the photographing space from the image acquired by photographing the subject.

14. The method of claim 12, wherein the separating includes calculating a difference between the image acquired by photographing the subject using the color lighting and the second subject separation reference image, when the subject has the same color as the background within the photographing space based on the decision result.

15. The method of claim 14, wherein the separating includes calculating a difference between the image acquired by photographing the subject using the basic lighting and the first subject separation reference image, when the subject does not have the same color as the background within the photographing space based on the decision result.

16. The method of claim 15, wherein the basic lighting corresponds to a white light.

17. A preprocessing method of a multi-view image photographed in a portable studio including a photographing space and a plurality of cameras photographing the photographing space, the method comprising:
photographing each of a case where a subject exists within the photographing space marked by a marker and a case where the subject does not exist within the photographing space marked by the marker, using the plurality of cameras;
extracting coordinates of the marker from an image corresponding to each of the cases, and determining whether a difference of coordinates of the marker between the two images is greater than a threshold; and
calibrating the plurality of cameras depending on the decision result.

18. The method of claim 17, further comprising:
informing a user about shaking of a corresponding camera, when the difference of coordinates of the marker is greater than the threshold based on the decision result.

19. The method of claim 17, wherein the calibrating includes calibrating at least one of a position of a corresponding camera, a tilt thereof, a pan thereof, and a parameter thereof depending on a level of the difference of coordinates of the marker greater than the threshold.
